(19) United States
(12) Patent Application Publication
(10) Pub. No.: US 2003/0189697 A1
(43) Pub. Date: Oct. 9, 2003

(54) Archery range finder

(76) Inventor: Joe Cullison, Bend, OR (US)

Correspondence Address: GLENN C. BROWN, PC, 777 NW WALL STREET, SUITE 308, BEND, OR, 97701, US

(21) Appl. No.: 10/118,385

(22) Filed: Apr. 5, 2002

(51) Int. Cl. G01C 3/22

(52) U.S. Cl. 356/21

(57) ABSTRACT

A range finder including a transparent member having a reference line and a plurality of range indicating lines. The reference line and range indicating lines are spaced apart a predetermined distance corresponding to the distance to the target, and further corresponding to a predetermined dimension of the target. The predetermined distance is in one embodiment the distance between the belly and back of an animal such as a deer.

This invention relates to archery range finders, and in particular to a simple, reliable and accurate range finder that can be used in a variety of conditions and with a variety of game animals.

Archers continually confront the issue of accurately determining the distance to a target. Where the target is a game animal, the task is complicated by the short amount of time in which the archer must determine the range and shoot, varying weather and light conditions, and the tendency of some less experienced hunters to get a little excited during these final few seconds of the hunt.

Numerous archery range finders have been developed over the years, but have been either overly complicated to use, or that were not well suited to use in the wide range of conditions encountered while hunting.

A need therefore exists for an improved archery range finder that is simple, reliable, and adaptable for use with various types and sizes of targets. The present invention meets this need as described in greater detail below and with reference to the drawings.

### BRIEF DESCRIPTION OF THE DRAWINGS

FIG. 1 is a front view of a preferred embodiment of the invention.

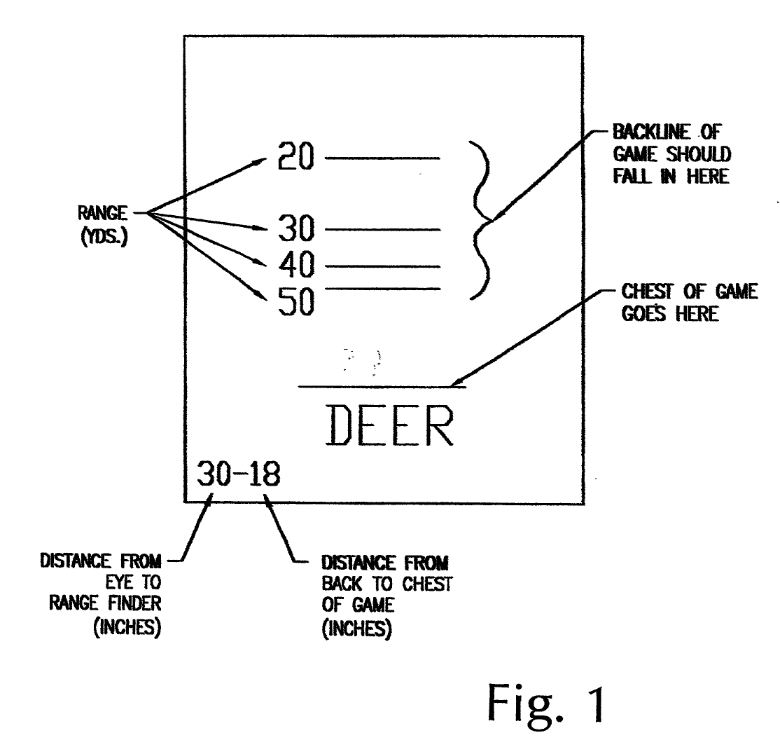

FIG. 2 is a front view of the embodiment shown in FIG. 1 and in which a target animal is shown as it would appear to a user.

### DETAILED DESCRIPTION OF THE PREFERRED EMBODIMENTS

Turning now to the drawings, a preferred embodiment of the invention is shown generally at 10. The range finder includes a transparent panel 12 that is preferably made of a polymeric material that is resistant to the effects of UV radiation and weather in order to maintain its transparency. The panel is shown as rectangular, but could be formed in any desired shape. While the embodiment shown is colorless, in other embodiments the panel could be formed of a colored or filtering material. For example, it is known that in flat light, e.g. diffuse light often encountered during heavy overcast days in combination with snowfall, an amber lens will highlight details of the target and the target area. Accordingly, the panel can be formed of any color of transparent material, or of a material that filters a particular portion of the spectrum to enhance the viewing of the target.

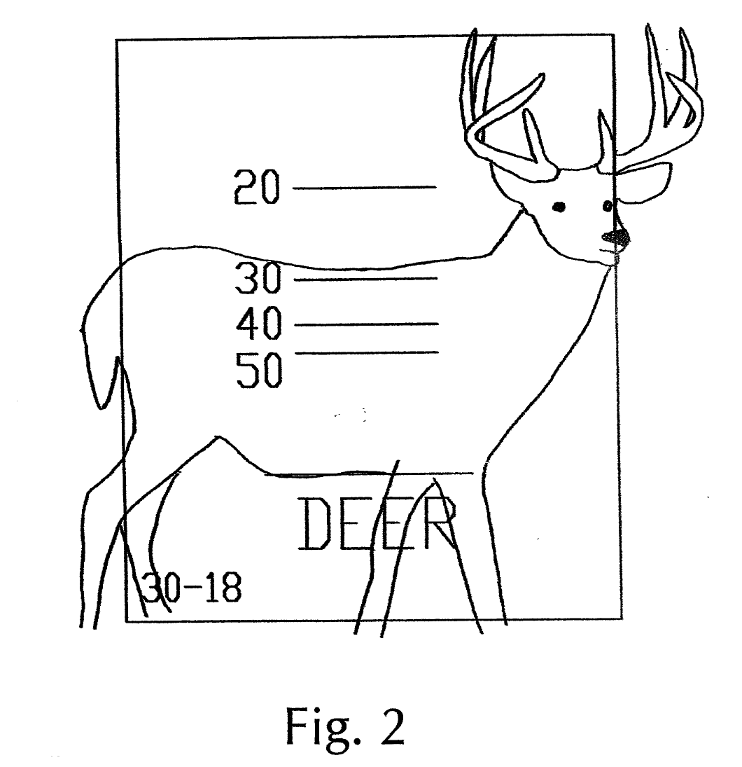

The panel includes a number of markings that are positioned on the panel in predetermined positions. The markings include a base line 14, an a series of range indicating lines 16, 18, 20, and 22 that in the embodiment shown indicate ranges of 20, 30, 40 and 50 yards respectively. The range finder is used by positioning the panel between the user's eye and the target, aligning the base line with a predetermined portion of the target. The range to the target is indicated by the position of a second predetermined portion of the target relative to lines 16, 18, 20, and 22. Turning to FIG. 2, the embodiment shown is one that is used for deer in which the distance from the stomach to the back is about 18 inches, and where the panel is held at about 30 inches from the user's eye, as indicated by the markings in the lower left corner of the panel. As shown in FIG. 2, the base line 14 is positioned roughly at the belly of the deer, and the back of the deer falls between lines 16 and 18, indicating a range of about 28 to 29 yards to the deer. In this 20 embodiment, the range finder 10 is held in the user's hands at arm's length, which for an average user places the range finder about 30 inches from the user's eye. The range finder can also be held in position in several other ways. The range finder can be mounted directly on the bow, or on a mounting bracket that is in turn mounted on the bow. In each instance, the distance to the user's eye can be readily determined and an appropriate spacing of lines 16, 18, 20, and 22 can be determined.

The range finder can also be used with targets of different sizes by adjusting the spacing of the lines 16, 18, 20, and 22. For example, 18 inches is a typical stomach to back distance for a mature black tail deer in the mountain regions of the west. Other species of deer, e.g. an eastern white tail deer living at lower elevations, the stomach to back distance is about 24 inches. In that embodiment, the spacing of the lines 16, 18, 20 and 22 would be adjusted accordingly, also taking into account the distance from the user's eye at which the range finder will be positioned.

The foregoing description of preferred embodiments of the invention is intended to illustrate the invention, and is not intended to limit the invention to the embodiments described. Those of skill in the art will recognize that numerous modifications in detail and arrangement are possible without departing from the scope of the following claims.

What is claimed is:

1. A range finder comprising:
a generally planar member having a transparent portion;
a first reference position on the planar member;
at least one range indicator formed on the planar member and spaced vertically apart from the first reference position; and,
the first reference position and the at least one range indicator alignable with a remote target, and spaced apart a predetermined distance that corresponds to a predetermined range from a user to the target.

2. A range finder according to claim 1 wherein the first reference position and the at least one range indicator comprise lines formed on the transparent portion of the planar panel.

3. A range finder according to claim 1 wherein the first reference position and the at least one range indicator spaced apart a predetermined distance that corresponds to a predetermined range from the user to a target further comprises the predetermined distance corresponding to a predetermined dimension of the target.

4. A range finder according to claim 3 wherein the predetermined dimension of the target comprises a distance between the belly and back of an animal.

5. A range finder according to claim 3 wherein the distance between the belly and back of an animal is a distance between 12 and 48 inches.

6. A range finder according to claim 1 further comprising the archery range finder mounted a predetermined distance from a user's eye.

7. A range finder comprising:
a transparent panel;
a reference line formed on the transparent panel;
a plurality of range indicating lines formed on the transparent panel and spaced vertically apart from the reference line; and,
each range indicating line indicating a predetermined distance to a target when the reference line is aligned with a predetermined portion of the target.

8. A range finder according to claim 8 wherein the target is an animal, and the predetermined portion of the target is the lower edge of the animal's belly, and the wherein each range indicating line is positioned to indicate a distance to the animal when aligned with the upper edge of the animal's back.

9. A range finder according to claim 8 wherein the range indicating lines are spaced apart from the reference line a distance corresponding to a predetermined distance between the animal's belly and back.
